(19) United States
(12) Patent Application Publication
(10) Pub. No.: US 2008/0157645 A1
(43) Pub. Date: Jul. 3, 2008

(54) Lamp with a Holder on One Side

(75) Inventors: Joachim Arndt, Brieselang (DE); Uwe Fidler, Berlin (DE); Markus Herb, Gunzburg (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHLAMPHEN MBH, MUNCHEN (DE)

(21) Appl. No.: 11/883,623

(22) PCT Filed: Feb. 2, 2006
(86) PCT No.: PCT/DE2006/000163

§ 371 Date: Aug. 2, 2007

(30) Foreign Application Priority Data
Feb. 4, 2005 (DE) 10 2005 005 264.9

(51) Int. Cl. H01J 5/50

(52) U.S. Cl. 313/318.09

(57) ABSTRACT

An electric lamp with a holder on one side, particularly a high-pressure discharge lamp, comprising a vacuum-tight sealed inner vessel which is surrounded by a surrounding part, wherein one holder with electrical connections bears the inner vessel and the surrounding part. The lamp is characterized by the following features: a) the holder is comprised of a holder stone having a central opening and a surrounding collar in which the inner vessel is accommodated; b) the holder stone has an element for fixing the surrounding part, c) the surrounding part has a circular opening on the holder side, that has a given inner diameter ID, and has a radially outwardly protruding enlargement with a given outer diameter UB, which is used as a holding member on the holder stone, wherein the ratio UB:ID=1.25; d) the surrounding part is fixed to the holder stone by a cement-free mechanical holding mechanism.

### TECHNICAL FIELD

The invention relates to a lamp with a base at one end in accordance with the precharacterizing clause of claim 1. The lamps in question here are in particular high-pressure discharge lamps, preferably metal-halide lamps, but also halogen incandescent lamps, for example. Use is frequently made in this case of an elongated, in particular ceramic, discharge vessel as the lamp bulb.

### PRIOR ART

DE-C1-43 17 252 has already disclosed a lamp with a base at one end which comprises three bulbs. It has a ceramic adaptor, which is fitted to a screw-type base. Atmospheric pressure prevails between the envelope and the outer bulb.

EP-A 1 109 199 describes a high-pressure lamp with a base at one end, in which the outer bulb is surrounded by a reflector. The base is fastened directly to the reflector neck by means of crimping. One disadvantage of this is the fact that the dimensions of the neck of the reflector need to be matched to the standard dimensions of the base.

PCT/DE2004/001710 (not yet published) has likewise disclosed a lamp with a base at one end, in which the envelope has a radially outwardly protruding enlarged portion. The production therefore requires a considerable amount of complexity. The envelope is in this case produced from pressed glass, as is the enlarged portion. This enlarged portion is therefore given the characteristic of being able to bear a sealing ring.

### DESCRIPTION OF THE INVENTION

The object of the present invention is to provide a lamp with a base at one end in accordance with the precharacterizing clause of claim 1 which is simple to produce and which in particular also is simple to fit and can be produced in a manner which can easily be automated.

This object is achieved by the characterizing features of claim 1. Particularly advantageous configurations can be gleaned from the dependent claims.

The lamp according to the invention with a base at one end has an inner vessel, which is sealed in a vacuum-tight manner, in particular a lamp bulb of an incandescent lamp, or else an elongated discharge vessel, which, under some circumstances, is also accommodated in an outer bulb. The inner vessel is also surrounded by an enveloping part. This enveloping part preferably has walls which are as thin as possible; in particular the wall thickness is from 1.5 to 2.3 mm. In the case of lamps subjected to a low load with a power rating of up to 50 W, the material may be soft glass, such as soda-lime-silica glass, for example. However, it is preferably resistant to high temperatures and comprises quartz glass or hard glass; in particular borosilicate glass is very suitable, such as Duran® by Schott, for example.

The inner vessel is preferably a modular unit comprising a discharge vessel with an outer bulb. It is particularly preferably a ceramic discharge vessel, in particular for a metal-halide lamp, for example for general lighting purposes. In this case, a base with electrical terminals bears the inner vessel, on the one hand, and the enveloping part, on the other hand. The electrical terminals are normally connected to power supply lines, which produce an electrical contact with a luminous means in the interior of the inner vessel; for example the luminous means is realized by electrodes or a luminous element of an incandescent lamp. Without restricting the invention, it is also possible to use outer electrodes or a configuration without electrodes. Instead of a ceramic discharge vessel, it is also possible to use a discharge vessel made from quartz glass or hard glass. An outer bulb as part of the inner vessel is not absolutely necessary, but is desirable.

According to the invention, the combination of the following features is used so as to do away with laborious mounting on a frame and hot processes such as fuse-sealing or baking of the base cement:

a) the base has a base insulator, which is produced from an insulating material and has an axially aligned central opening with a surrounding collar, in which the inner vessel is accommodated;
b) the base insulator has means which make it possible to hold the enveloping part; in particular the means have a radially protruding segment which is circular, in particular with an associated (in relation to the base) upper and lower plateau;
c) the enveloping part has, at the base end, a circular opening with a given outer diameter AD and a given inner diameter ID and has means for holding it on the base insulator which interact with the holding means of the base insulator; a radially outwardly protruding step, in particular an enlarged portion, with a maximum outer diameter of the protrusion ÜB, which is brought about in particular by virtue of the fact that the edge is deformed, the ratio ÜB:ID≦1.25;
d) the enveloping part is fastened to the base insulator by means of a cementless mechanical holding mechanism incorporating the means from b) and c).

In particular, the enlarged portion is in the form of a droplet or boot. This is particularly possible when the enveloping part is produced from borosilicate glass. However, the outwardly pointing protrusion is essential.

Particularly simple shaping of the narrow edge, which now absolutely only makes a protrusion on the outer wall of the envelope of approximately 0.6 to 1.1 mm, consists in the process of flame-rounding, but heating is also possible by means of lasers or plasma. This method comprises the following steps:

a) providing an enveloping part with a smooth edge region of its circular-cylindrical opening;
b) heating a region around the opening until the glass softens, the enveloping part possibly being positioned vertically;
c) possibly shaping the edge, as long as the glass is still soft.

The edge of the enveloping part consisting of glass is advantageously enlarged in the form of a droplet or boot, which is possible in particular in a simple manner by means of flame-rounding.

The flame-rounding is produced by the flame of a gas burner. It can produce a “droplet”, freely rounded, which forms owing to the surface tension. Depending on the alignment of the enveloping part, for example the horizontal or vertical position of the axis, in this case different shapes result. The softened edge can, however, also be applied to a shaping tool after heating by means of the flame as long as the heated edge is still sufficiently warm. Any desired shape of the edge can therefore be produced. It is recommended in this case to allow the tube to be deformed to rotate in each case. The technique of flame-rounding has long been known per se, but has a high potential in terms of economy in connection with the enveloping part consisting of glass.

The enveloping part is in particular fastened to the base insulator by virtue of the fact that a clamp part bridges the distance between the lower plateau of the base insulator and at least the upper contact face of the edge in a holding fashion. In this case, there is normally no need for a sealing ring. The clamp part may be, for example, an aluminum strip.

In addition to the base insulator, the base has a conventional part facing the lampholder, for example a screw-type base attachment or a bayonet-type base attachment or a GU base.

Preferably, the inner vessel, i.e. the lamp bulb or the outer bulb, for example, which contains a discharge vessel, or the discharge vessel in the case of the absence of an outer bulb, is held in the central opening by means of a spring clip.

A simple, reliable and cost-effective solution for holding the enveloping part consists in the clamp part comprising clamps distributed over the circumference or a circumferential clamping strip. In particular, the clamping strip is a deformable ring, which is produced in particular from metal or plastic, with the result that very simple holding is made possible by virtue of the fact that the clamping strip is first applied to the lower plateau in such a way that it is already bent back at an angle and then drawn up beyond the protruding segment on impact. As soon as the enveloping part is positioned, the clamping strip, preferably an aluminum ring, can be integrally formed mechanically on the protruding segment as far as the upper contact face. The edge of the enveloping part is fixed by means of being bent around the upper contact face.

Preferably, no damping means is introduced between the clamp part and the upper contact face of the edge of the enveloping part. The omission is in particular possible because the envelope is relatively light owing to its thin wall thickness.

However, the use of this means has not been ruled out. It is in particular a type of O ring, for example consisting of an elastomer. The material of the enveloping part, advantageously glass or aluminum, is thereby protected from damage during the process of integral formation. A further advantage is the fact that, as a result, the connecting force between the enveloping part and the segment is maintained without play over the life of the lamp. Owing to the damping ring, the tensioning of the clamp part can be increased without any risk and therefore the connection can be designed to be more reliable.

Power supply lines are generally passed out of the lamp bulb and are connected to the electrical terminals of the base.

In addition, the base generally has a part which faces the lampholder and is connected at least partially as known per se by means of crimping to the base insulator. This part contains, for example, a conventional screw-type thread or pin or a bayonet-type base etc.

The enveloping part may be, for example, a closed part such as a further envelope, which is not sealed in a vacuum-tight manner, however, or else a spherical cap, which has a reflector contour. The enveloping part is produced from a vitreous material.

A typical application is a metal-halide lamp, which contains a filling with or without a mercury content, possibly with inert ignition gas, advantageously noble gas.

### BRIEF DESCRIPTION OF THE DRAWINGS

The invention will be explained in more detail below with reference to a plurality of exemplary embodiments. In the drawings:

FIG. 1 shows a basic illustration of the metal-halide lamp, in a side view;

FIG. 2 shows the envelope with an edge (2a) and the edge in a detailed view (2b);

FIG. 3 shows further embodiments of the edge (3a and 3b and 3c);

FIG. 4 shows examples of the manner in which the edge is anchored in the base insulator (4a and 4b).

### PREFERRED EMBODIMENT OF THE INVENTION

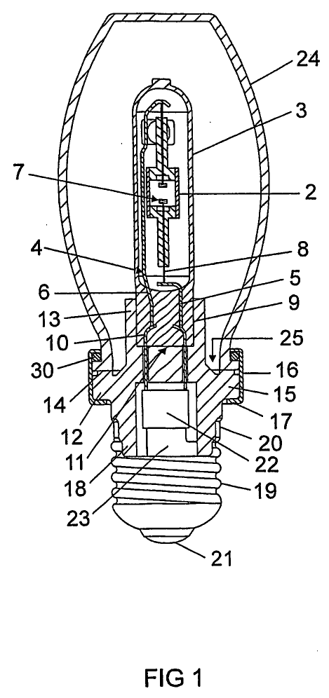

An exemplary embodiment of a metal-halide lamp 1 is shown in FIG. 1. A ceramic discharge vessel 2, which is sealed at two ends, is arranged extending longitudinally in the lamp axis A. It is tightly surrounded by an outer bulb 3, which is pinch-sealed at one end and is produced from hard glass. Both parts 2, 3 together form the inner vessel (2, 3). A frame 4 with a short and a long feed line 5, 6 holds the discharge vessel 2 in the outer bulb 3. The electrodes 7 in the interior of the discharge vessel are connected to the feed lines 5, 6 via leadthroughs 8. Said feed lines 5, 6 are connected to external power supply lines 10 in the region of a pinch seal 9, which seals the outer bulb 3. The pinch seal 9 of the outer bulb rests in a matching opening 11 of a base insulator 12 consisting of ceramic and is held there by a metal clip 34. The base is essentially formed from the base insulator 12 and a screw-type base part 19. This opening 11 is surrounded by a central collar part 13. It protrudes out of a plane which forms the upper plateau 14 of a radially protruding disk-shaped segment 15. The segment 15 is furthermore designed to have a side wall 16 and a lower plateau 17. It rests on a neck part 18, which holds a part associated with the lampholder, in this case a screw-type base part 19 with a thread. The screw-type base 19 is fastened to the neck part 18 by means of crimping 20. The neck part 18 is hollow on the inside, the power supply lines 10 being connected to electrical terminals 21 of the base via an insulation displacement connection 22 in the cavity 23 of the neck part. Similarly suitable are also other mechanical connection techniques or a conventional welded joint.

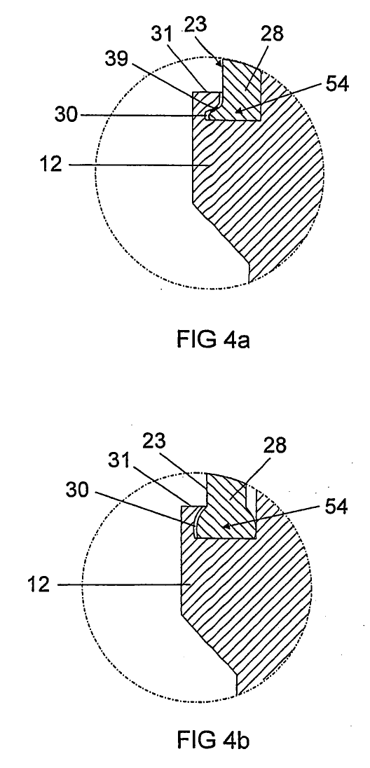

An envelope 24, which surrounds the outer bulb 3 at a relatively large distance, has a base-side opening 25, which is circular-cylindrical and is matched in terms of diameter to the outer diameter of the segment 15. A buffer part 39 (illustrated in FIG. 4a) can also be introduced between the two parts, which are matched to one another in terms of shape and dimensions, which buffer part 39 may be, for example, a silicone seal.

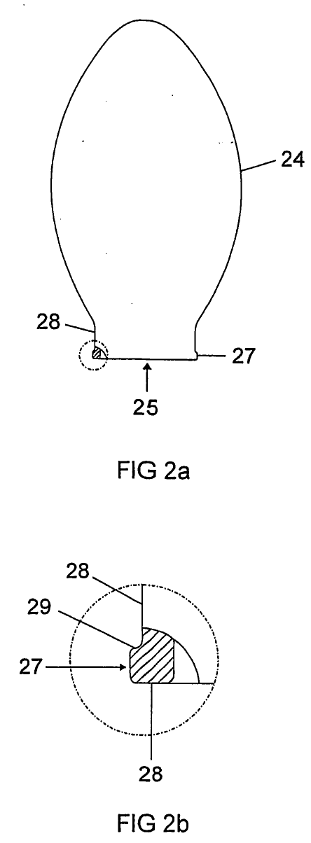

The envelope 24 is equipped at its opening 25 with a radially protruding step 27, see in this regard also FIG. 2. It is approximately in the form of a boot and preferably has a flat lower contact face 28, which is matched to the upper plateau 14 of the segment of the base insulator. The upper plateau may have humps, which space apart the upper plateau 14 from the envelope. In addition, it has a narrow upper contact face 29 which is aligned parallel to the lower contact face 28 or else at an angle with respect thereto. An elastomer ring 30, for example consisting of Viton®, rests on it.

The step 27 is provided by virtue of the fact that it is produced as an enlarged portion. This enlarged portion is achieved by flame-rounding 26 the edge region of the enveloping part at the opening. The enveloping part may have, in particular, a straight neck 28 as an attachment in the region of its opening, see FIG. 1. In this case, care must be taken when carrying out the flame-rounding to ensure that the step is deformed at the edge in such a way that the outer diameter of the edge is larger than the neck diameter. This also applies similarly to the contour and the neck of a spherical cap in the case of reflector lamps if the reflector is a glass one. In the present exemplary embodiment, the inner diameter of the neck is 24.5 mm, the outer diameter is 28 mm. The diameter of the enlarged portion 29.4 mm.

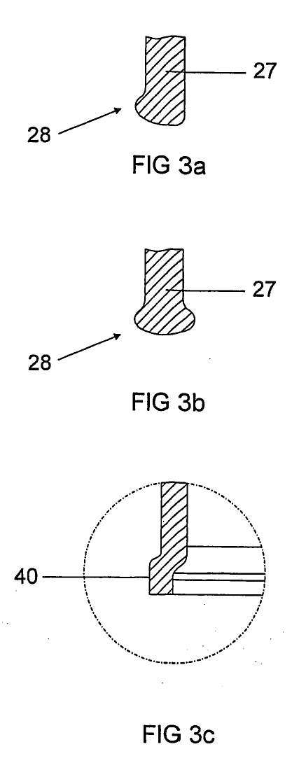

FIG. 3 shows further examples of the configuration of the edge of the enveloping part, in which case, given the shape in FIGS. 3a and 3b, no shaping was necessary, but merely the force of gravity was used to deform the suitably positioned enveloping part. In the exemplary embodiment shown in FIG. 3c, the lower edge is in the form of a step 40, which can be produced, for example, by means of a glass blow form. In this case, the wall thickness remains approximately constant.

FIG. 4 shows two examples of shaped, enlarged edges, this shape being very suitable for being fastened in a base part, even without additional clamps. It is held by virtue of the fact that the base insulator comprises two parts and has a circumferential channel.

The base insulator 12 advantageously has a circumferential groove 30 on its surface which points towards the enveloping part 23, which circumferential groove 30 runs in the vicinity of the outer edge (FIGS. 4a and 4b). The outer edge of the groove 30 is partially provided with a roof 31 (FIG. 5b), which still leaves sufficient space in the groove for the wall of the neck 28. As a result of the fact that the base insulator comprises at least two parts, the enlarged portion 54 of the enveloping part 23 can be grasped from behind in a simple manner by the roof 31 of the groove 30, as a result of which the enveloping part 23 is locked against the base insulator 12. FIG. 4a shows the fact that, advantageously, an elastic ring in the groove provides a secure, firm hold for the enveloping part on the base insulator.

1. An electric lamp with a base at one end, in particular a high-pressure discharge lamp, having an inner vessel (2, 3) which is sealed in a vacuum-tight manner, said vessel being surrounded by an enveloping part (24), a base with electrical terminals bearing the inner vessel, on the one hand, and the enveloping part, on the other hand, characterized by the combination of the following features:
a) the base has a base insulator (12), which is produced from an insulating material and has a central opening (11) with a surrounding collar (13; 63), in which the inner vessel is accommodated;
b) the base insulator has a fastening means for the enveloping part;
c) the enveloping part has, at the base end, a circular opening with a given inner diameter ID and has, as means for holding it on the base insulator, a radially outwardly protruding step, in particular an enlarged portion, with a given outer diameter ÜB, the ratio ÜB:ID≦1.25;
d) the enveloping part is fastened to the base insulator by means of a cementless mechanical holding mechanism.

2. The lamp as claimed in claim 1, characterized in that the enveloping part is fastened to the base by means of a clamp part which bridges the distance between a lower plateau of the base insulator and an upper contact face of the enlarged portion in a holding fashion.

3. The lamp as claimed in claim 1, characterized in that the enlarged portion is in the form of a droplet or boot.

4. The lamp as claimed in claim 1, characterized in that the step is produced by means of heating a region at the opening, in particular by means of flame-rounding.

5. The lamp as claimed in claim 2, characterized in that the clamp part comprises clamps distributed over the circumference or a circumferential clamping strip.

6. The lamp as claimed in claim 5, characterized in that the clamping strip is a deformable ring, a multi-part ring connected by means of a cohesive connection or a ring having sprung elements or in that the clamps distributed over the circumference are deformable or sprung elements or elements which are connected by an interlocking or cohesive or force-fitting connection.

7. The lamp as claimed in claim 2, characterized in that a damping means is introduced between the clamp part and the upper contact face of the edge of the enveloping part, or between the lower contact face of the edge of the enveloping part and the upper plateau of the base insulator, or between the clamp part and the lower plateau of the base insulator.

8. The lamp as claimed in claim 7, characterized in that the damping means is an O ring.

9. The lamp as claimed in claim 1, characterized in that the enveloping part is produced from a vitreous material, in particular from hard glass or quartz glass, preferably from borosilicate glass.

10. The lamp as claimed in claim 1, characterized in that the enveloping part is an enclosed bulb or has a reflector contour.

11. The lamp as claimed in claim 1, characterized in that the enveloping part is fastened to the base by virtue of the fact that the base insulator has a circumferential channel on its surface, in which channel the edge of the enveloping part is accommodated, the channel having a roof.

12. The lamp as claimed in claim 11, characterized in that an elastic ring is introduced between the enlarged portion and the roof.

13. A method for producing a lamp as claimed in claim 1, characterized in that the method comprises the following steps:
a) providing an enveloping part with a circular opening;
b) suitably heating a region around the opening, in particular with a gas flame, so as to produce an enlarged portion which protrudes radially outwards;
c) possibly shaping the enlarged portion.
